(19) United States
(12) Patent Application Publication
(10) Pub. No.: US 2026/0326184 A1
(43) Pub. Date: Oct. 22, 2026

(54) AUXILIARY STRUCTURE FOR DIE REPLACEMENT OF BADGE MACHINE

(71) Applicant: Yaohui Cao, Zhengzhou City (CN)

(72) Inventor: Yaohui Cao, Zhengzhou City (CN)

(21) Appl. No.: 19/180,282

(22) Filed: Apr. 16, 2025

(51) Int. Cl. B21D 37/04; B21D 39/03

(52) U.S. Cl. CPC B21D 37/04; B21D 39/031

(57) ABSTRACT

Disclosed in the present disclosure is an auxiliary structure for die replacement of a badge machine, the auxiliary structure includes a locking matching end arranged on a rotating plate and an unlocking assembly mounted at the locking matching end, where the unlocking assembly at least includes a mounting main body and a locking member, in a locked state, the locking member is connected to the locking mating end, the mounting main body is locked and mounted behind a clamping slot hole, and an adapter upright rod is restricted from being separated backward from the clamping slot hole; and in an unlocked state, the locking member and the locking matching end are disconnected, the mounting main body is capable of moving relative to the rotating plate and releases locking of the adapter upright rod, and the adapter upright rod is capable of being separated backward from the clamping slot hole.

### TECHNICAL FIELD

The present disclosure relates to the technical field of badge machines, and in particular to an auxiliary structure for die replacement of a badge machine.

### BACKGROUND

In order to improve production efficiency of badges and make a production process more simple, a current mainstream badge machine on the market is basically provided with two lower die holder placement stations. The badge is generally composed of an upper iron cover, a drawing, a plastic film and a lower cover. When the badge is made, the upper iron cover, the drawing and the plastic film are sequentially placed in one of the lower die seats, then placed under an upper die holder and pressed down, and then the lower cover is placed in the other lower die holder, and the lower die holder with the lower cover is moved to the position under the upper die holder and pressed down, thereby completing making of the badge.

The above two lower die holders and the upper die holder jointly form a badge making die, and a badge machine on the market is generally divided into two types according to different mounting modes of the two lower die holders, one is rail mounting, and during mounting, the two lower die holders realize position replacement through sliding; and the other is rotary mounting, during mounting, the two lower die holders are mounted on a rotating plate, and the rotating plate can rotate around a rotating rod, so as to realize position replacement of the two lower die holders. In order to more conveniently replace the rotating plate and the lower die holders in a badge machine with rotary mounting, in the prior art, a clamping slot hole is selected to be provided at the rotating plate, and the rotating plate is clamped and fixed on the rotating rod through the clamping slot hole. When medals of other sizes or models need to be manufactured by replacing the die, the rotating plate can be separated or mounted above a bottom plate through deformation of the clamping slot hole at the rotating plate only under slight exertion of force, thereby realizing replacement of a first lower die holder and a second lower die holder. However, in an actual use process, since it is necessary to ensure that the rotating plate can be separated from the clamping slot hole with a little force, a slot on the clamping slot hole will be made larger, which will cause connection between the clamping slot hole and the rotating rod to be unstable, and in a rotating process of the rotating plate around the rotating rod, the rotating plate will be usually separated from the rotating rod. Therefore, it is necessary to provide a brand-new solution which considers convenience for disassembly and does not affect structural stability.

### SUMMARY

In order to solve the above problem, the present disclosure proposes an auxiliary structure for die replacement of a badge machine.

The technical solutions used by the present disclosure are as follows: an auxiliary structure for die replacement of a badge machine, where the badge machine is provided with a bottom plate, an adapter upright rod and a rotating plate, and the adapter upright rod extends vertically and is fixed above the bottom plate. A front side edge of the rotating plate is provided with a clamping slot hole, the rotating plate is rotationally mounted on the adapter upright rod through the clamping slot hole, and the rotating plate is placed above the bottom plate. The auxiliary structure for die replacement includes a locking matching end arranged on the rotating plate and an unlocking assembly mounted at the locking matching end, where the unlocking assembly at least includes a mounting main body and a locking member. The auxiliary structure for die replacement has a locked state and an unlocked state, in the locked state, the locking member is connected to the locking mating end, the mounting main body is locked and mounted behind the clamping slot hole, and the adapter upright rod is restricted from being separated backward from the clamping slot hole. In the unlocked state, the locking member and the locking matching end are disconnected, the mounting main body is capable of moving relative to the rotating plate and releases locking of the adapter upright rod, and the adapter upright rod is capable of being separated backward from the clamping slot hole.

Further, the locking matching end at least comprises a fixing hole formed at the rotating plate, the locking member is provided with at least a fixing rod, and the fixing rod is correspondingly inserted into the fixing hole in the locked state; and in the unlocked state, the fixing rod is separated from the fixing hole, the clamping slot hole divides the rotating plate into a left station plate and a right station plate, a first lower die holder is fixedly mounted above the left station plate, a second lower die holder is fixedly mounted above the right station plate, a mounting vacancy for mounting the mounting main body is arranged on the rotating plate, and the mounting vacancy is arranged behind the clamping slot hole.

Further, the unlocking assembly is a first unlocking assembly, the locking member is a first fastening member, the mounting main body comprises a shifting and rotating main body, one end of the shifting and rotating main body is rotationally mounted on the right station plate, the other end of the shifting and rotating main body is used for being fastened and mounted on the left station plate in cooperation with the first fastening member, and in the locked state, a front end of the shifting and rotating main body abuts against the adapter upright rod.

Further, a first mounting slot position is arranged at a side, closest to the mounting vacancy, of the left station plate, a second mounting slot position is arranged at a side, closest to the mounting vacancy, of the right station plate, the fixing hole is a first screw hole provided at the first mounting slot position, a rotating shaft hole is provided at the second mounting slot position, one end of the shifting and rotating main body is provided with a first through hole, the other end of the shifting and rotating main body is provided with an adapter, the adapter is rotationally mounted in the rotating shaft hole, in the locked state, the first through hole and the first screw hole correspond to each other up and down, one end of the first fastening member is fastened and mounted in the first screw hole after passing through the first through hole, and in the unlocked state, the shifting and rotating main body rotates freely around the rotating shaft hole through the adapter.

Further, a first boss is arranged on the shifting and rotating main body, the first through hole is provided at the first boss, the first fastening member comprises a first knob and a first screw rod that are connected to each other, the first knob abuts against an upper portion of the first boss in the locked state, an insertion sheet is arranged on one side of the shifting and rotating main body, and the insertion sheet extends into the clamping slot hole in the locked state, and abuts against an outer side wall of the adapter upright rod.

Further, the unlocking assembly is a second unlocking assembly, the locking member is a second fastening member, the mounting main body comprises a push plate, in the locked state, the push plate is fastened and mounted on the left station plate or the right station plate through the second fastening member, and in the unlocked state the push plate slides into or out of the mounting vacancy.

Further, a first mounting slot position is arranged at a side, closest to the mounting vacancy, of the left station plate, a second mounting slot position is arranged at a side, closest to the mounting vacancy, of the right station plate, the fixing hole is a second screw hole provided at the first mounting slot position, a second through hole is provided at the push plate, in the locked state, the second through hole and the second screw hole correspond to each other up and down, and one end of the second fastening member is fastened and mounted in the second screw hole after passing through the second through hole.

Further, a second boss, and a handle bar extending in a left-right direction are arranged above the push plate, the second through hole extends upward to the second boss, the second fastening member comprises a second knob and a second screw rod that are connected to each other, the second knob abuts against an upper portion of the second boss in the locked state, and a notch matches and abuts against the adapter upright rod is provided at a front end of the push plate.

Further, the unlocking assembly is a third unlocking assembly, the mounting main body comprises a base, the locking member is a pressing member elastically mounted on the base, the base is slidably mounted in the mounting vacancy in a front-rear direction, and in the locked state, the pressing member cooperates to fasten and mount the base on the rotating plate; and in the unlocked state, the base and the pressing member jointly slide into or out of the mounting vacancy.

Further, the base comprises a base plate and an upper housing mounted above the base plate, the base plate is provided with a mounting seat for mounting a compressed spring, the pressing member comprises an inner connecting plate arranged inside the upper housing, a push button fixed above the inner connecting plate and at least one positioning post, the rotating plate is provided with at least one positioning hole, the compressed spring is arranged between the mounting seat and the push button, the positioning post and an upper end of the push button extend to a position above the upper housing in the locked state, and the positioning post is inserted into the positioning hole.

Compared with the prior art, the present disclosure has the following beneficial effects:
1. By arranging the locking matching end on the rotating plate and arranging the mounting vacancy at a position, in front of the clamping slot hole, of the rotating plate, after the mounting main body is placed in the mounting vacancy, the locking member is used for locking relative positions of the mounting main body and the rotating plate. Since the mounting main body is kept abutting against the adapter upright rod, the rotating plate can be effectively prevented from being separated from the adapter upright rod in a rotating process of the rotating plate around the adapter upright rod, such that structural stability is good.
2. When the rotating plate and a lower die holder on the rotating plate need to be replaced, locking of the mounting main body can be released only by breaking connection between the locking member and the rotating plate. In this case, the mounting main body can be moved, and abutting limit between the mounting main body and the adapter upright rod can be released, and only a little force is needed to make the rotating plate be separated from the adapter upright rod through deformation of the clamping slot hole, such that replacement of a first lower die holder and a second lower die holder can be realized.
3. The unlocking assembly and the locking matching end cooperate with each other, and unlocking and locking modes are very convenient. The structure is simple, and stability of a rotating structure between the rotating plate and the adapter upright rod is greatly enhanced on the premise of not affecting simple replacement of the rotating plate and the lower die holder.

### BRIEF DESCRIPTION OF THE DRAWINGS

FIG. 1 is a diagram from a first view of an integral structure in Example 1 of the present application.

FIG. 2 is a diagram from a second view of an integral structure in Example 1 of the present application.

FIG. 3 is a diagram from a third view of an integral structure after hiding of a first lower die holder in Example 1 of the present application.

FIG. 4 is a schematic structural diagram after hiding of a first lower die holder, disassembly of a first unlocking assembly and separation from a rotating plate in Example 1 of the present application.

FIG. 5 is a partially enlarged diagram of portion A in FIG. 4.

FIG. 6 is a schematic structural diagram of a rotating plate in Example 1 of the present application.

FIG. 7 is a schematic structural diagram of a first unlocking assembly in an example of the present application.

FIG. 8 is a schematic structural diagram of a second lower die holder in an example of the present application.

FIG. 9 is a diagram from a first view of an integral structure in Example 2 of the present application.

FIG. 10 is a diagram from a second view of an integral structure in Example 2 of the present application.

FIG. 11 is a schematic structural diagram after hiding of a first lower die holder, disassembly of a second unlocking assembly and separation from a rotating plate in an example of the present application.

FIG. 12 is a schematic structural diagram of a rotating plate in Example 2 of the present application.

FIG. 13 is a schematic structural diagram from a lower side view of a second unlocking assembly in an example of the present application.

FIG. 14 is a diagram of an integral structure in a locked state in Example 3 of the present application.

FIG. 15 is a partially enlarged diagram of portion B in FIG. 14.

FIG. 16 is a diagram of an integral structure in an unlocked state in Example 3 of the present application.

FIG. 17 is a partially enlarged diagram of portion C in FIG. 16.

FIG. 18 is a schematic structural diagram of a rotating plate in Example 3 of the present application.

FIG. 19 is a schematic structural diagram after disassembly of a third unlocking assembly and separation from a rotating plate in Example 3 of the present application.

FIG. 20 is an exploded schematic diagram from an upper side view of a third unlocking assembly in Example 3 of the present application.

FIG. 21 is an exploded schematic diagram from a lower side view of a base plate and an upper housing in Example 3 of the present application.

FIG. 22 is a schematic structural diagram of a pressing member in an example of the present application.

FIG. 23 is a sectional view of a badge machine involved in an example of the present application.

FIG. 24 is a partially enlarged diagram of portion D in FIG. 23.

Reference numerals in the figures: 1-bottom plate, 2-rotating plate, 21-left station plate, 211-first placing slot, 212-first clamping post, 213-first slot hole, 214-first mounting slot position, 215-first screw hole, 216-second screw hole, 217-first spring, 22-right station plate, 221-second placing slot, 222-second clamping post, 223-second slot hole, 224-second mounting slot position, 225-rotating shaft hole, 226-second spring, 23-clamping slot hole, 24-mounting vacancy, 25-shifting bar, 26-lateral slot, 261-upper guide opening, 262-lower guide opening, 27-positioning hole, 28-recess, 3-adapter upright rod, 31-upright rod main body, 32-inner connecting rod, 4-first unlocking assembly, 41-shifting and rotating main body, 42-insertion sheet, 43-first boss, 431-first through hole, 44-adapter, 45-first fastening member, 5-second unlocking assembly, 51-push plate, 52-notch, 53-handle bar, 54-second boss, 541-second through hole, 55-extension sheet, 56-second fastening member, 6-third unlocking assembly, 61-base plate, 611-mounting seat, 612-insertion post, 613-clamping block, 614-guide sheet, 62-upper housing, 621-insertion seat, 622-clamping opening, 63-pressing member, 631-inner connecting plate, 632-push button, 6321-skidproof grain, 633-positioning post, 634-penetrating hole, 64-compressed spring, 7-first lower die holder, 71-first stop rod, 8-second lower die holder, 81-second stop rod, 82-mounting hole, 9-supporting beam frame, 91-limiting block, 92-strip-shaped hole, 93-handrail member, 10-handle, 101-driving and pressing block, 11-connecting plate, 111-connector, 112-first magnetic block, 12-positioning upright rod, 13-upper die holder, 131-second magnetic block, 132-rotation stop block, 14-reset assembly, 141-linkage rod, and 142-reset spring.

An implementation of the objective, functional characteristics and advantages of the present disclosure will be further described with reference to the accompanying drawing and in combination with the embodiments.

### DETAILED DESCRIPTIONS OF THE EMBODIMENTS

### Particular implementation solutions

### Example 1

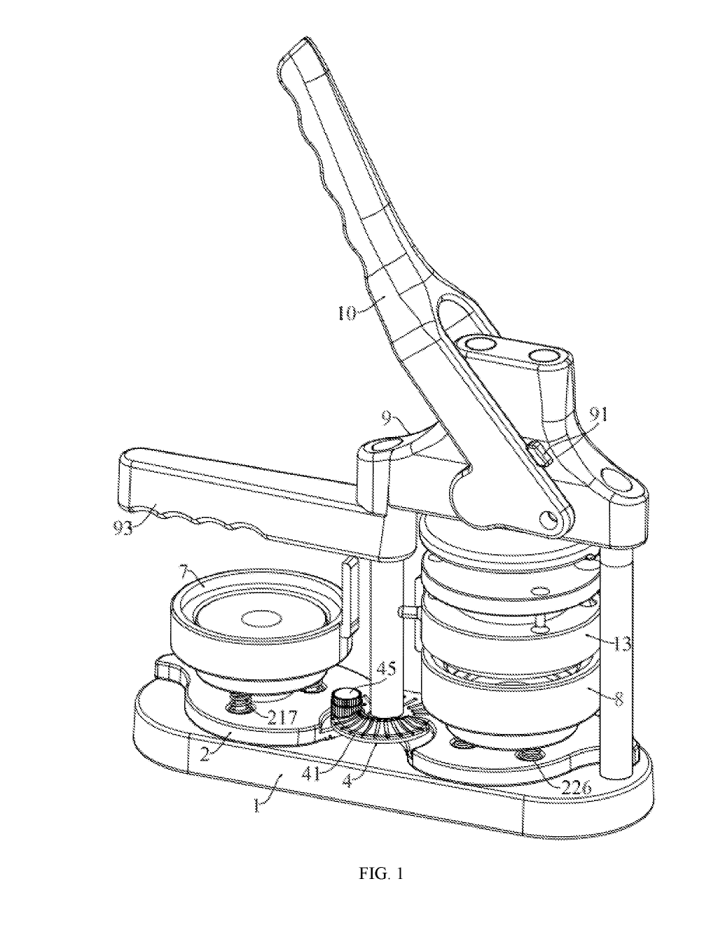

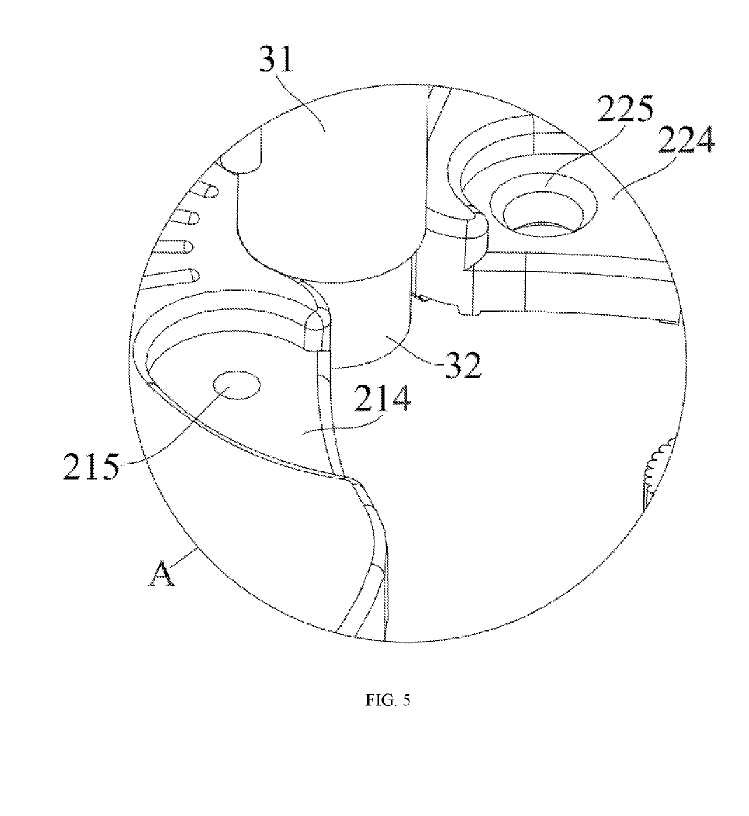

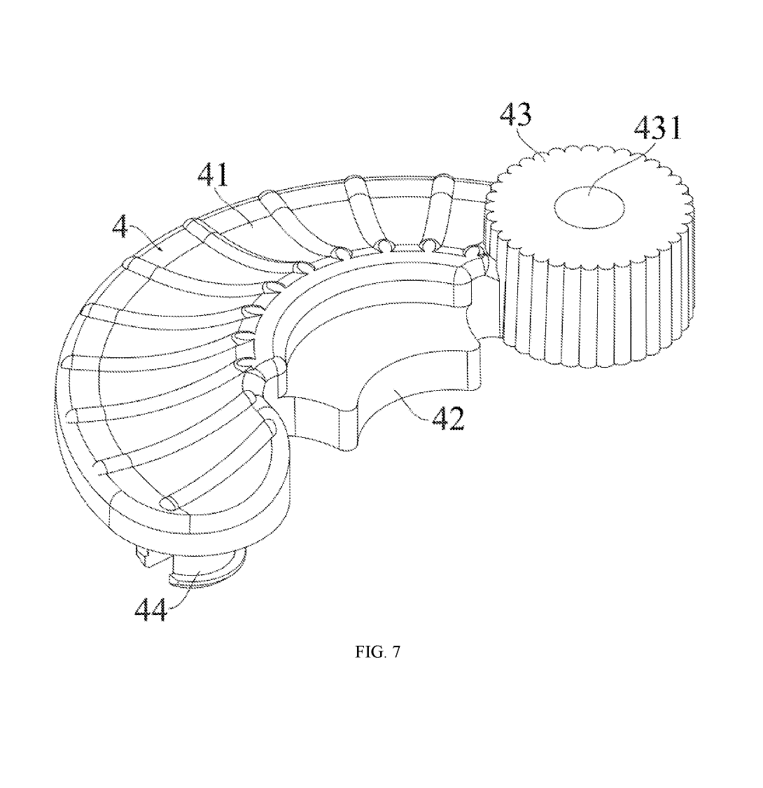

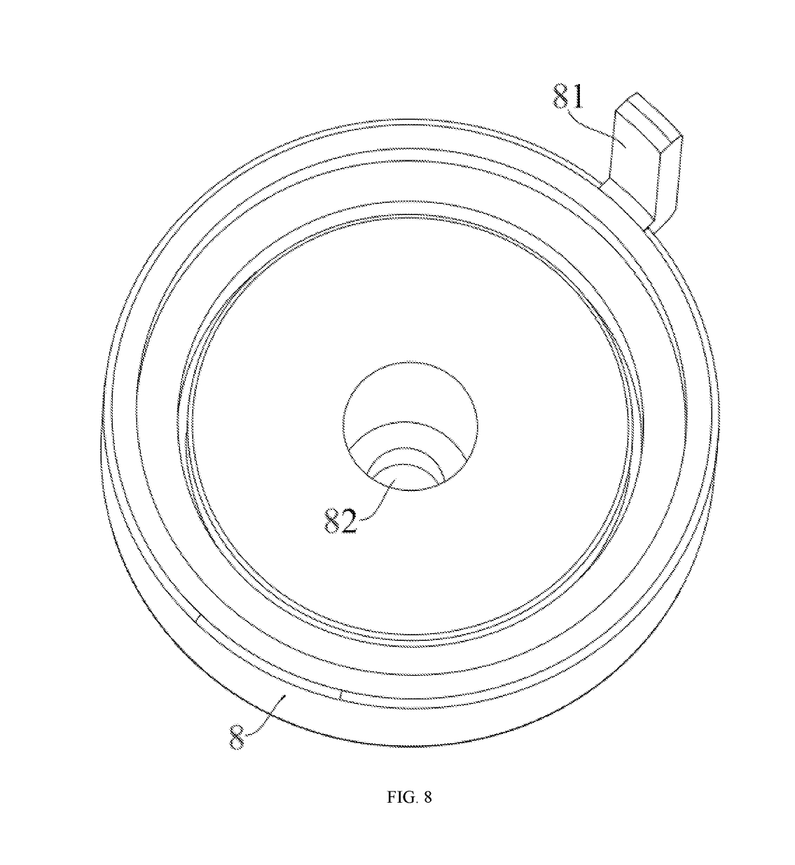

Referring to FIGS. 1-8, 23 and 24, the present disclosure provides an auxiliary structure for die replacement of a badge machine, where the badge machine is provided with a bottom plate 1, an adapter upright rod 3 and a rotating plate 2, and the adapter upright rod 3 extends vertically and is fixed above the bottom plate 1. A front side edge of the rotating plate 2 is provided with a clamping slot hole 23, the rotating plate 2 is rotationally mounted on the adapter upright rod 3 through the clamping slot hole 23, and the rotating plate 2 is placed above the bottom plate 1. The auxiliary structure for die replacement includes a locking matching end arranged on the rotating plate 2 and an unlocking assembly mounted at the locking matching end, where the unlocking assembly at least includes a mounting main body and a locking member. The auxiliary structure for die replacement has a locked state and an unlocked state. In the locked state, the locking member is connected to the locking mating end, the mounting main body is locked and mounted behind the clamping slot hole 23, and the adapter upright rod 3 is restricted from being separated backward from the clamping slot hole 23; and in the unlocked state, the locking member and the locking matching end are disconnected, the mounting main body is capable of moving relative to the rotating plate 2 and releases locking of the adapter upright rod 3, and the adapter upright rod 3 is capable of being separated backward from the clamping slot hole 23.

As a preferred embodiment of this example, the locking matching end at least includes a fixing hole formed at the rotating plate 2, and the locking member is at least provided with one fixing rod. In the locked state, the fixing rod and the fixing hole are in corresponding insertion connection, and in the unlocked state, the fixing rod is separated from the fixing hole.

For convenience of understanding, the structure and working principle of the badge machine involved in this example are firstly described below:

Referring to FIGS. 1-4, 23 and 24, it can be seen that the clamping slot hole 23 divides the rotating plate 2 into a left station plate 21 and a right station plate 22, where a first lower die holder 7 is fixedly mounted above the left station plate 21, a second lower die holder 8 is fixedly mounted above the right station plate 22, a mounting vacancy 24 for mounting a mounting main body is arranged on the rotating plate 2, and the mounting vacancy 24 is arranged in front of the clamping slot hole 23.

In addition, a positioning upright rod 12 is fixedly mounted above the bottom plate 1 of the badge machine, a supporting beam frame is mounted above the adapter upright rod 3 and the positioning upright rod 12, a handle 10 is hinged on the supporting beam frame, and a connecting plate 11 is arranged below the supporting beam frame 9. A reset assembly 14 is arranged between the supporting beam frame 9 and the connecting plate 11, a driving and pressing block 101 is arranged at one end of the handle 10, and a user can rotate the handle 10 to drive and press the connecting plate 11 to translate downward through the driving and pressing block 101.

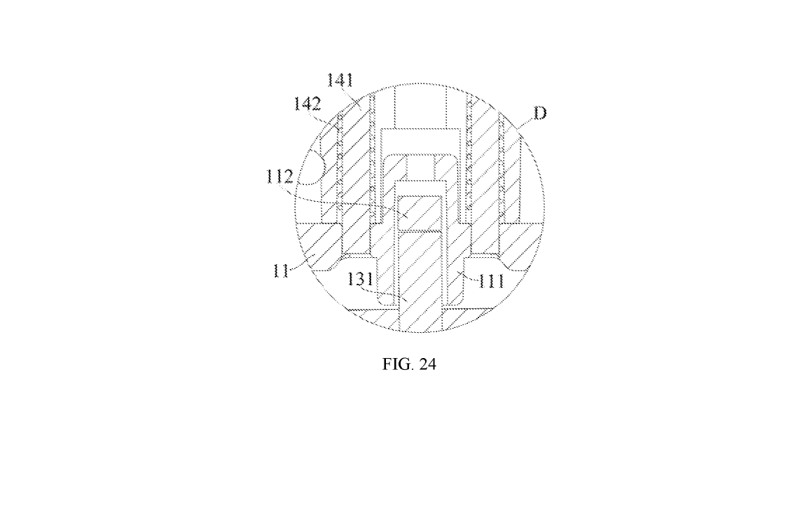

Referring to FIGS. 23 and 24 and , the connecting plate 11 is provided with a connector 111, and an upper end of the connector 111 extends into the supporting beam frame 9. A first magnetic block 112 is arranged inside the connector 111, a second magnetic block 131 is arranged at an upper end of an upper die holder 13, and the upper die holder 13 is mounted below the connecting plate 11 through magnetic attraction of the first magnetic block 112 and the second magnetic block 131. Therefore, when the connecting plate 11 is driven to translate downward, the upper die holder 13 translates downward together with the connecting plate 11. In addition, two strip-shaped holes 92 extending vertically are provided inside the supporting beam frame. The reset assembly 14 includes a linkage rod 141 and a reset spring 142, where the linkage rod 141 is mounted in the strip-shaped holes 92, a lower end of the linkage rod 141 is fixed on the connecting plate 11, and the reset spring 142 is arranged outside the linkage rod 141 in a sleeving manner. During the downward translation of the connecting plate 11 and the upper die holder 13, the linkage rod 141 also descends along with the connecting plate 11, and the reset spring 142 is compressed. After the handle 10 is released, since downward pressure of the driving and pressing block 101 on the connecting plate 11 disappears, the reset spring 142 recovers through deformation and drives the linkage rod 141, the connecting plate 11 and the upper die holder 13 to translate upward together.

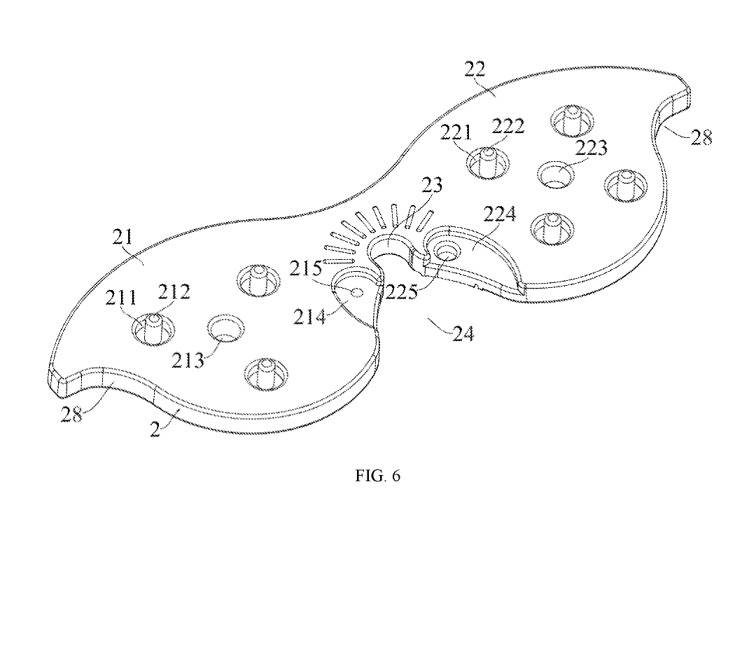

Referring to FIG. 6, it can be seen that the left station plate 21 and the right station plate 22 are provided with recesses 28 at the sides away from each other. When the first lower die holder 7 or the second lower die holder 8 rotates directly below an upper die holder 13, the positioning upright rod 12 is clamped in the recess 28. In this example, a concave contour of the recess 28 has a limiting direction, that is, a rotation angle of the rotating plate 2 is limited to half a circle, and a rotation direction of the rotating plate 2 is limited, such that when the positioning upright rod 12 is clamped in the recess 28, one of the first lower die holder 7 or the second lower die holder 8 is just below the upper die holder 13.

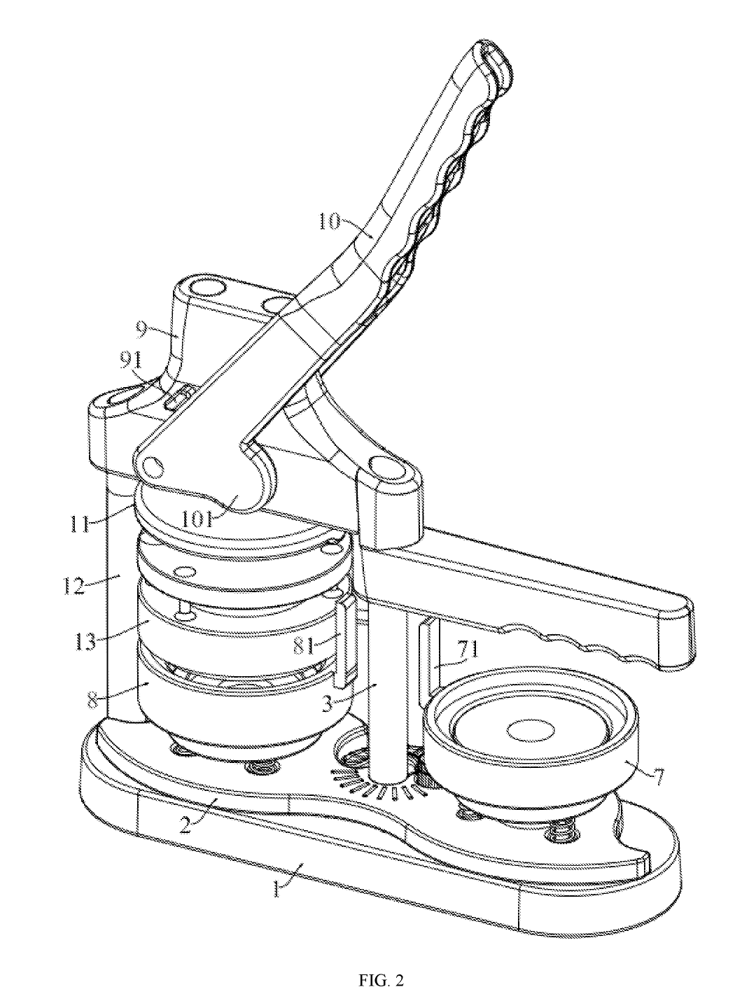

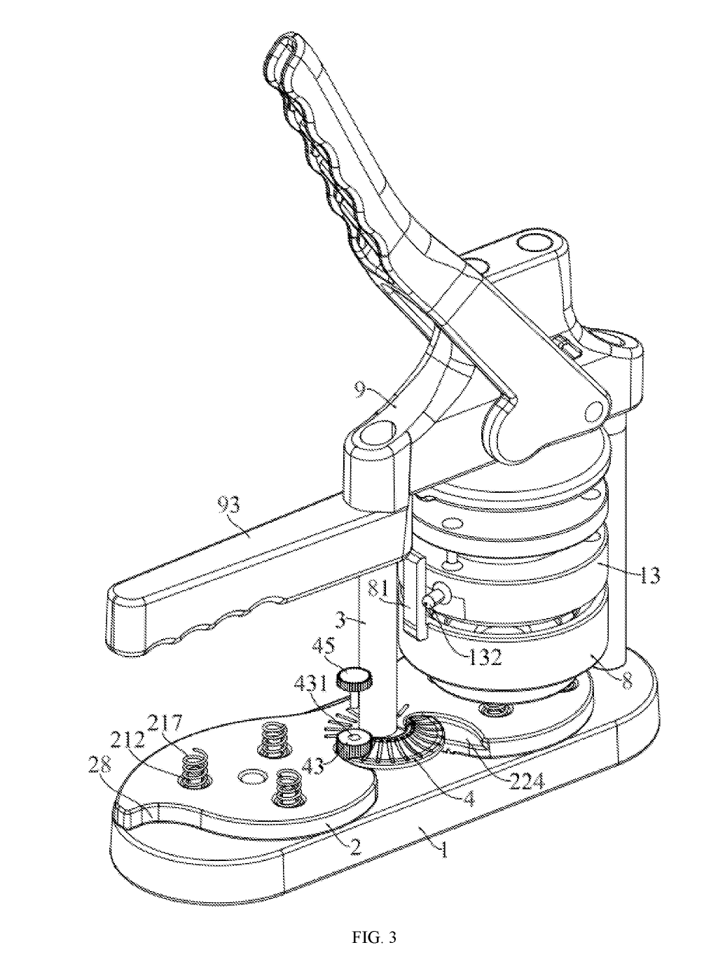

In addition, referring to FIG. 2, it can be seen that in order to limit rotation of the handle 10, in this example, limiting blocks 91 are arranged on a front side and a rear side of the supporting beam frame 9. Referring to FIGS. 2 and 3, it can be seen that, in this example, a first stop rod 71 extending upward is arranged on an outer side wall of the first lower die holder 7, a second stop rod 81 extending upward is arranged on an outer side wall of the second lower die holder 8, and a rotation stop block 132 is arranged on an outer side wall of the upper die holder 13. The first stop rod 71, the second stop rod 81 and the rotation stop block 132 are additionally designed to jointly cooperate with the recesses 28 to limit the rotation direction and the rotation angle of the rotating plate 2, such that an operator can more easily position the first lower die holder 7 or the second lower die holder 8 and accurately rotate the corresponding die holder directly below the upper die holder 13. The rotation stop block 132 plays a rotation limit role, when the first lower die holder 7 rotates directly below the upper die holder 13, the first stop rod 71 abuts against the rotation stop block 132.

In addition, in this example, one side of the supporting beam frame 9 is fixedly provided with a handrail member 93, and during operation, the user can grasp the handrail member 93, so as to better complete downward rotation of the handle 10.

Referring to FIGS. 6 and 8, it can be seen that in this example, the left station plate 21 is provided with a first slot hole 213, the right station plate 22 is provided with a second slot hole 223, and the second lower die holder 8 is provided with a mounting hole 82. The mounting hole 82 of the second lower die holder 8 is opposite to a second through hole 541, such that the second lower die holder 8 can be fixed above the right station plate 22 by screws. Similarly, the first lower die holder 7 can be fixed above the left station plate 21.

In addition, in this example, the left station plate 21 is provided with a plurality of first placing slots 211, the first placing slots 211 are provided with first clamping posts 212 for the first springs 217 to be arranged in a sleeved manner, the right station plate 22 is provided with a plurality of second placing slots 221, and the second placing slots 221 are provided with second clamping posts 222 for the second springs 226 to be arranged in a sleeved manner. The first springs 217 and the second springs 226 are arranged to cushion lower portions of the first lower die holder 7 and the second lower die holder 8 when the first lower die holder 7 or the second lower die holder 8 is pressed down through the upper die holder 13.

Referring to FIGS. 1-5, in this example, the unlocking assembly is a first unlocking assembly 4, the locking member is a first fastening member 45, the mounting main body includes a shifting and rotating main body 41, one end of the shifting and rotating main body 41 is rotationally mounted on the right station plate 22, and the other end of the shifting and rotating main body is used for being fastened and mounted on the left station plate 21 in cooperation with the first fastening member 45. In the locked state, a front end of the shifting and rotating main body 41 abuts against the adapter upright rod 3.

In this example, the adapter upright rod 3 includes an upright rod main body 31 and an inner connecting rod 32 arranged at a lower end of the upright rod main body 31. An insertion sheet 42 is arranged at a rear side of the shifting and rotating main body 41. In the locked state, the insertion sheet 42 is inserted a lower portion of the upright rod main body 31 and abuts against an outer side wall of the inner connecting rod 32, so as to better limit a position of the adapter upright rod 3 and prevent the adapter upright rod 3 from being separated from the clamping slot hole 23.

Then, referring to FIG. 6, it can be seen that in this example, a first mounting slot position 214 is arranged at a side, closest to the mounting vacancy 24, of the left station plate 21, a second mounting slot position 224 is arranged at a side, closest to the mounting vacancy 24, of the right station plate 22, the fixing hole is a first screw hole 215 provided at the first mounting slot position 214, and a rotating shaft hole 225 is provided at the second mounting slot position 224. One end of the shifting and rotating main body 41 is provided with a first through hole 431, the other end of the shifting and rotating main body is provided with an adapter 44, and the adapter 44 is rotationally mounted in the rotating shaft hole 225. In the locked state, the first through hole 431 and the first screw hole 215 correspond to each other up and down, one end of the first fastening member 45 is fastened and mounted in the first screw hole 215 after passing through the first through hole 431, and in the unlocked state, the shifting and rotating main body 41 rotates freely around the rotating shaft hole 225 through the adapter 44.

In this example, a first boss 43 is arranged on the shifting and rotating main body 41, and the first through hole 431 is provided at the first boss 43. The first fastening member 45 includes a first knob and a first screw rod that are connected to each other, and the first knob abuts against an upper portion of the first boss 43 in the locked state. An insertion sheet 42 is arranged on one side of the shifting and rotating main body 41, and the insertion sheet 42 extends into the clamping slot hole 23 in the locked state, and abuts against an outer side wall of the adapter upright rod 3.

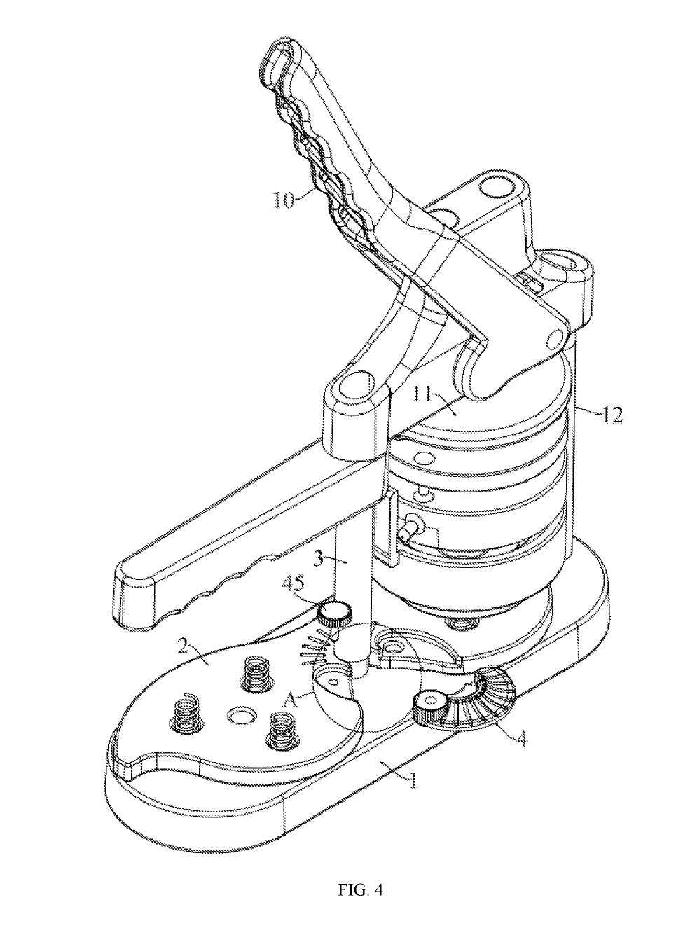

Referring to FIGS. 3 and 4, when it is necessary to switch to the unlocked state, firstly, the first knob needs to be rotated to screw the first screw rod out of the first screw hole 215, and then the first fastening member 45 can be taken out. Then, the user can press the shifting and rotating main body 41 and drive same to rotate counterclockwise around the rotating shaft hole 225 (it should be noted that due to the design of the insertion sheet 42 on the shifting and rotating main body 41, if the insertion sheet 42 is not rotated away from the clamping slot hole 23, the insertion sheet 42 will abut against a lower end of the upright rod main body 31, such that the shifting and rotating main body 41 fails to be taken out upward). Finally, the user can take out the shifting and rotating main body 41 upward, and unlocking is completed.

When it is necessary to switch to the locked state again, firstly, the adapter 44 of the shifting and rotating main body 41 is inserted into the rotating shaft hole 225. Then, the shifting and rotating main body 41 is rotated clockwise until the first through hole 431 at the shifting and rotating main body is aligned with the first screw hole 215, in this case, the insertion sheet 42 abuts against an outer wall of the inner connecting rod 32. Finally, the first fastening member 45 is mounted at the first through hole 431 and the first screw hole 215, and locking is completed.

In addition, in this example, in order to better shift the shifting and rotating main body 41, skidproof grains are arranged on an upper surface of the shifting and rotating main body 41.

### Example 2

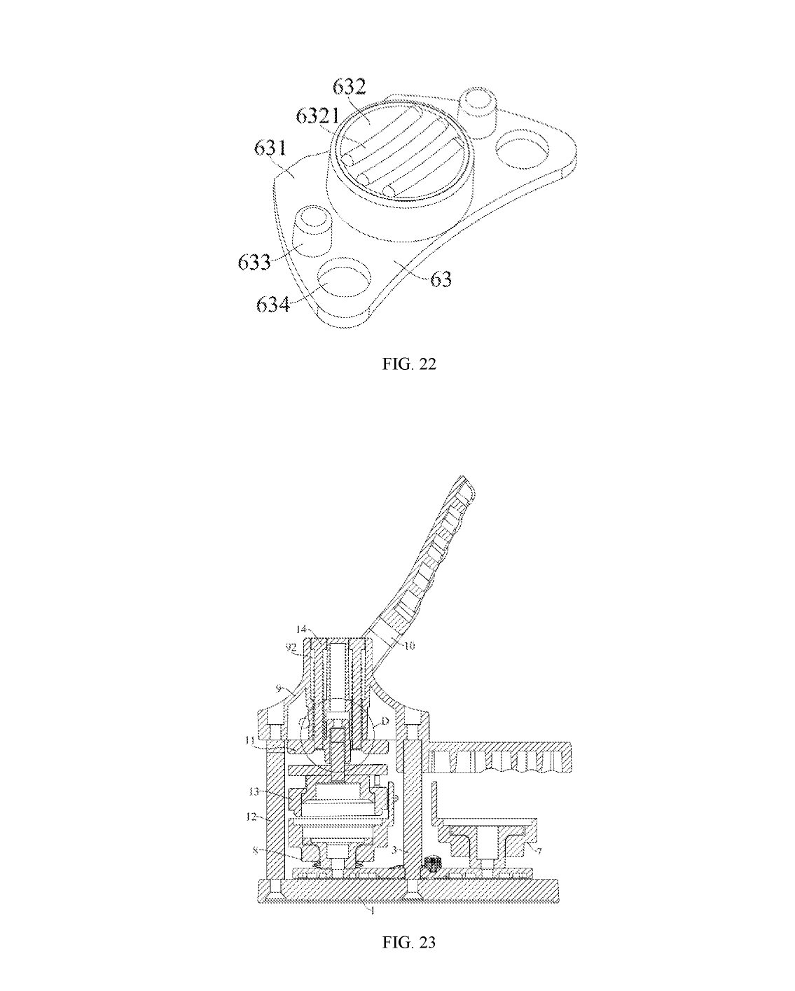

Referring to FIGS. 14-22, being different from Example 1, in this example, the unlocking assembly is a second unlocking assembly 5, and the locking member is a second fastening member 56. The mounting main body includes a push plate 51, in the locked state, the push plate 51 is fastened and mounted on the left station plate 21 or the right station plate 22 through the second fastening member 56, and in the unlocked state, the push plate 51 slides into or out of the mounting vacancy 24.

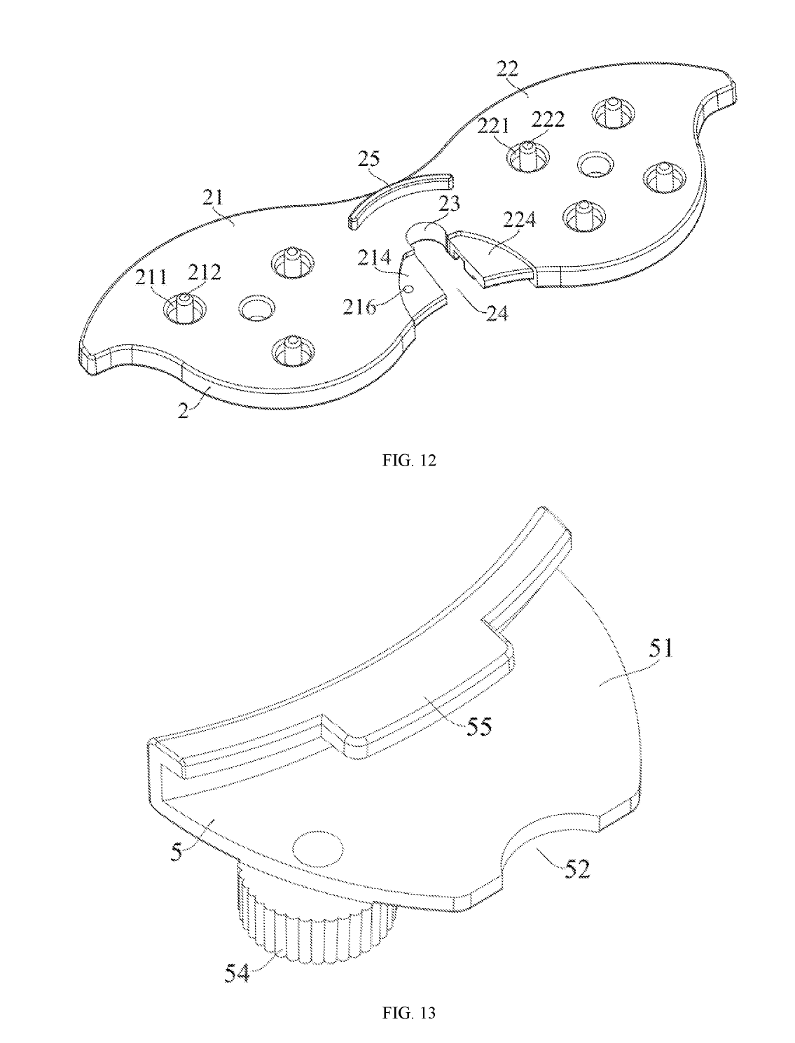

Then, referring to FIG. 12, it can be seen that in this example, a first mounting slot position 214 is arranged at a side, closest to the mounting vacancy 24, of the left station plate 21, a second mounting slot position 224 is arranged at a side, closest to the mounting vacancy 24, of the right station plate 22, and the fixing hole is a second screw hole 216 provided at the first mounting slot position 214. A second through hole 541 is provided at the push plate 51, in the locked state, the second through hole 541 and the second screw hole 216 correspond to each other up and down, and one end of the second fastening member 56 is fastened and mounted in the second screw hole 216 after passing through the second through hole 541.

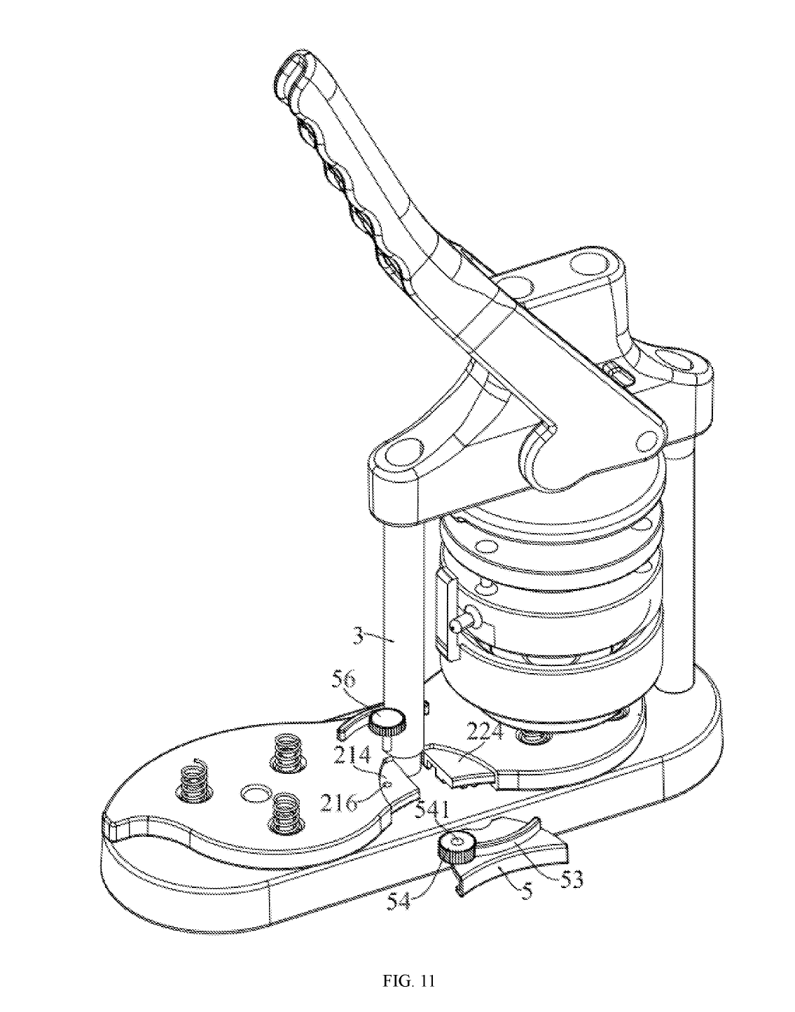

In addition, referring to FIGS. 11 and 13, in this example, a second boss 54, and a handle bar 53 extending in a left-right direction are arranged above the push plate 51, and the second through hole 541 extends upward to the second boss 54. The second fastening member 56 includes a second knob and a second screw rod that are connected to each other, the second knob abuts against an upper portion of the second boss 54 in the locked state, and a notch 52 matches and abuts against the adapter upright rod 3 is provided at a front end of the push plate 51.

In this example, an extension sheet 55 extending forward is arranged at a rear side of a lower end of the push plate 51. In the locked state, the extension sheet 55 abuts against a lower end surface of the rotating plate 2, so as to better fix a position of the push plate 51.

Referring to FIG. 11, when it is necessary to switch to the unlocked state, firstly, the second knob needs to be rotated to screw out the second screw rod from the second screw hole 216, and then the second fastening member 56 can be taken out. Next, the user can manually shift the handle bar 53 backward to push the push plate 51 out of the mounting vacancy 24 to a rear side, and unlocking is completed.

When it is necessary to switch to the locked state again, firstly, the push plate 51 needs to be pushed forward into the mounting vacancy 24, and the notch 52 abuts against the outer wall of the inner connecting rod 32 (structure of the adapter upright rod 3 is the same as that of Example 1). In this case, the second through hole 541 is aligned with the second screw hole 216, and then, the second fastening member 56 is mounted at the second through hole 541 and the second screw hole 216, thereby completing locking.

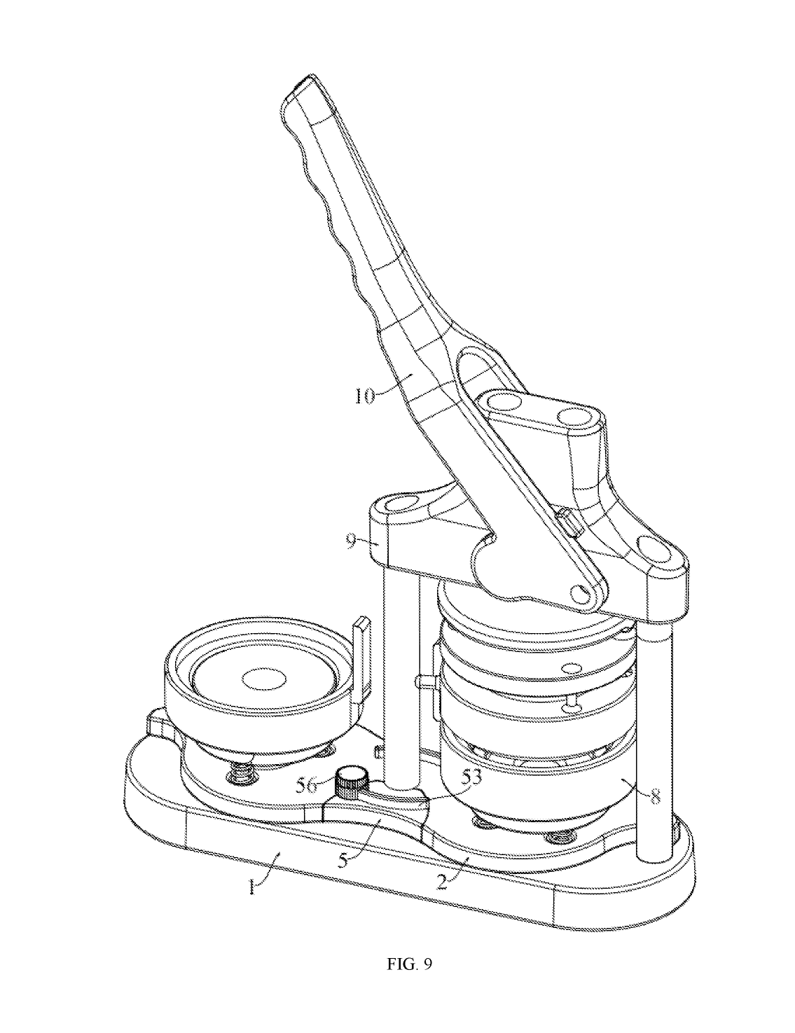

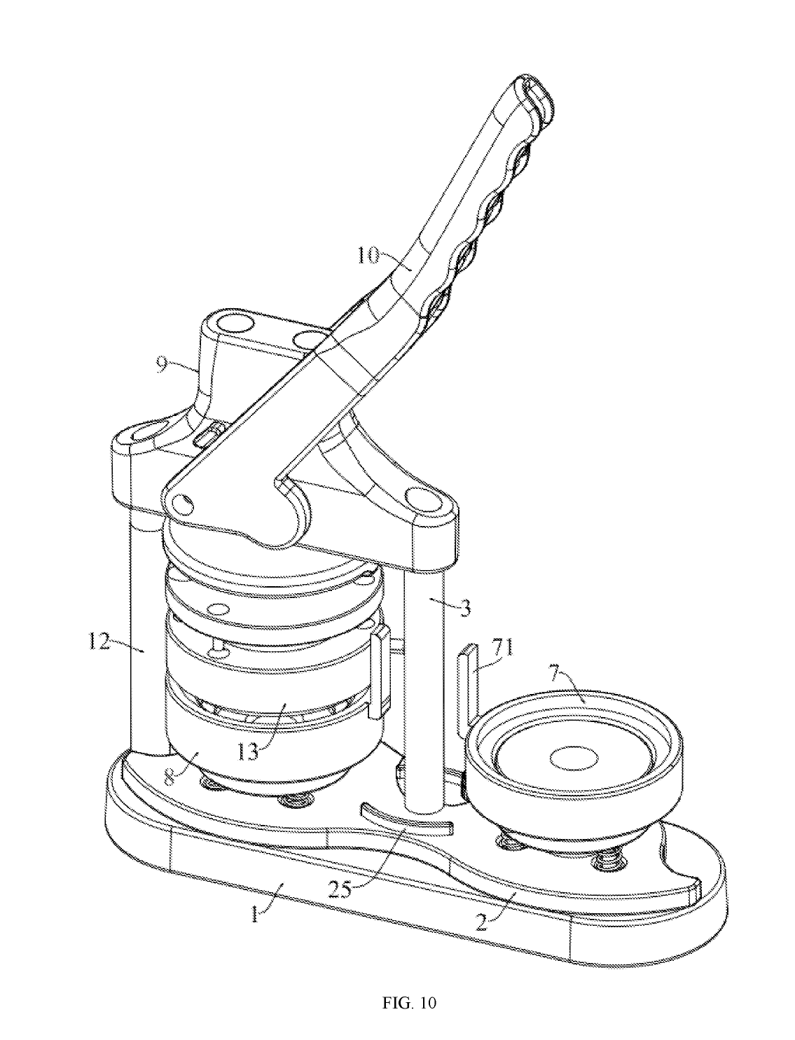

Referring to FIG. 10, it can be seen that in this example that a shifting bar 25 is fixed above the rotating plate 2, and the shifting bar 25 is arranged in front of the adapter upright rod 3. In the unlocked state, the user can shift the shifting bar 25 to detach the rotating plate 2 from the adapter upright rod 3 under push to other position of the rotating plate 2.

### Example 3

Referring to FIGS. 14-22, being different from Example 1 and Example 2, in this example, the unlocking assembly is a third unlocking assembly 6, the mounting main body includes a base, the locking member is a pressing member 63 elastically mounted on the base, and the base is slidably mounted in the mounting vacancy 24 in a front-rear direction. In the locked state, the pressing member 63 cooperates to fasten and mount the base on the rotating plate 2, and in the unlocked state, the base and the pressing member 63 jointly slide into or out of the mounting vacancy 24.

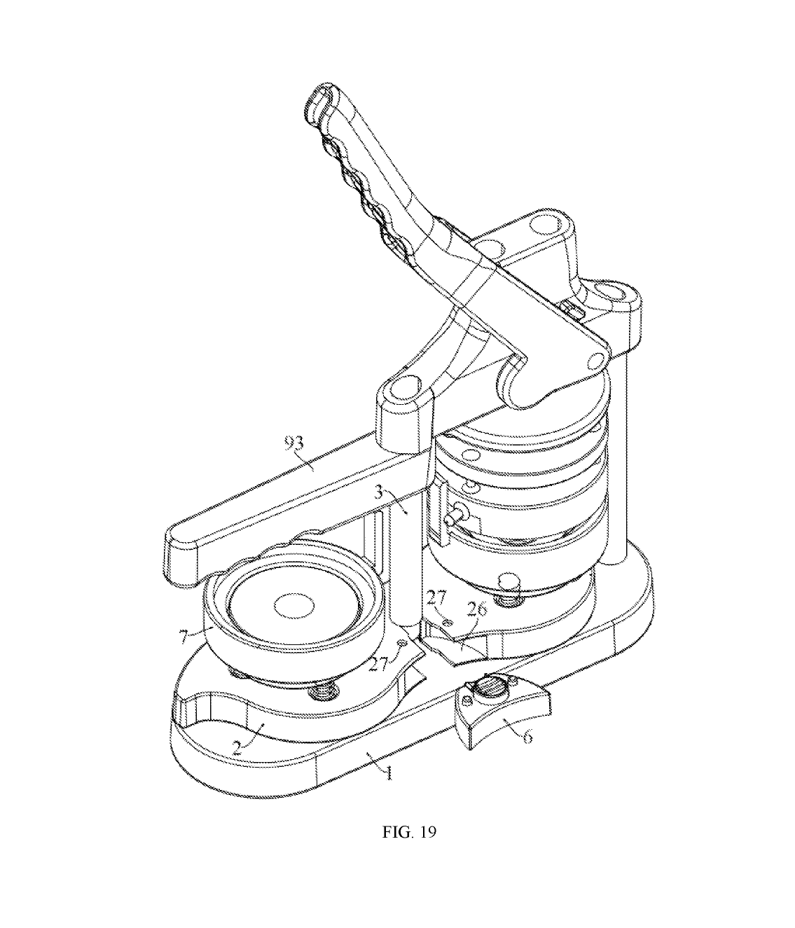

Referring to FIGS. 18 and 19, it can be seen that in this example, a front end of the rotating plate 2 is provided with a lateral slot 26, and an upper side and a lower side of the lateral slot 26 are provided with an upper guide opening 261 and a lower guide opening 262 respectively.

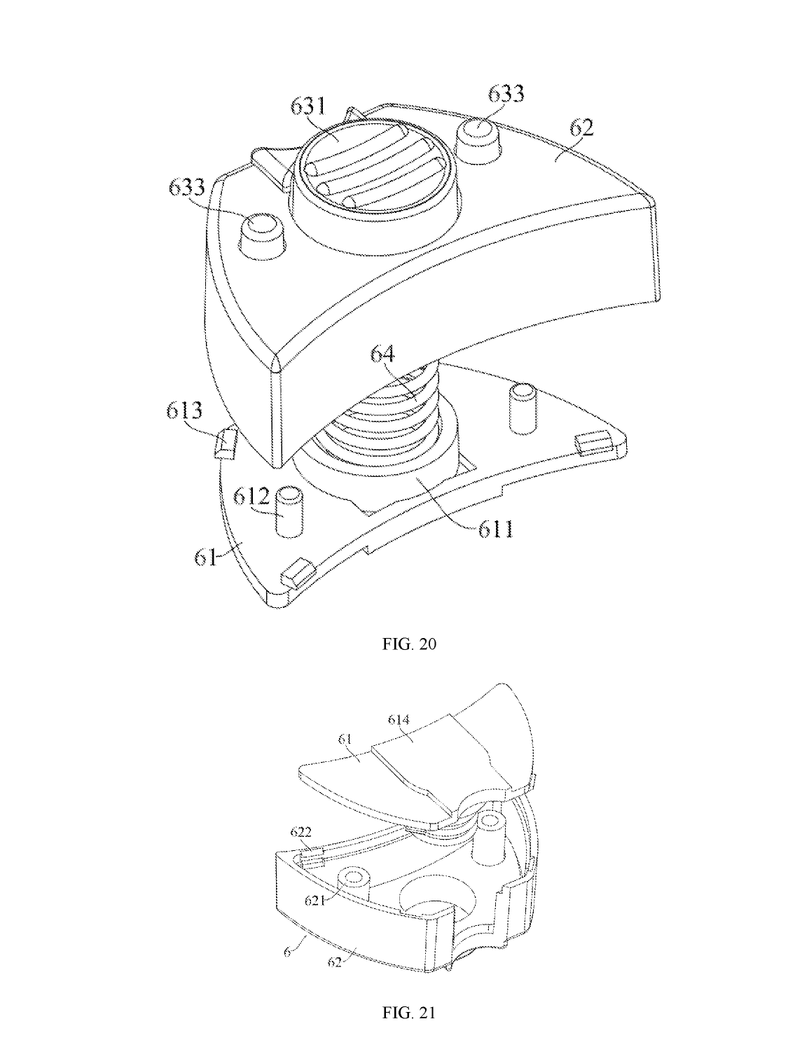

In addition, referring to FIGS. 20-22, in this example, the base includes a base plate 61 and an upper housing 62 mounted above the base plate 61, and the base plate 61 is provided with a mounting seat 611 for mounting a compressed spring 64. The pressing member 63 includes an inner connecting plate 631 arranged inside the upper housing 62, a push button 632 fixed above the inner connecting plate 631 and at least one positioning post 633. The rotating plate 2 is provided with at least one positioning hole 27, the compressed spring 64 is arranged between the mounting seat 611 and the push button 632, the positioning post 633 and an upper end of the push button 632 extend to a position above the upper housing 62 in the locked state, and the positioning post 633 is inserted into the positioning hole 27.

In this example, a plurality of insertion posts 612 are arranged on the base plate 61, a plurality of insertion seats 621 are arranged inside the upper housing 62, and a plurality of penetrating holes 634 are provided at the inner connecting plate 631. When the base is assembled, the inner connecting plate 631 needs to be mounted inside the upper housing 62 through butt joint between the insertion seats 621 and the penetrating holes 634, and then, the base plate 61 with the compressed springs 64 is fixed below the lower housing through insertion connection between the insertion posts 612 and the insertion seats 621. In this case, the compressed spring 64 abuts between the mounting seat 611 and the push button 632.

In addition, in this example, a plurality of clamping blocks 613 are arranged on an edge of the base plate 61, and a plurality of clamping openings 622 are provided at a lower edge of the upper housing 62. The clamping blocks 613 and clamping openings 622 are designed to more firmly assemble the base plate 61 and the upper housing 62. Moreover, in this example, a guide sheet 614 extending in a front-rear direction is arranged at a lower end of the base plate 61, and skidproof grains 6321 are arranged at an upper end of the push button 632.

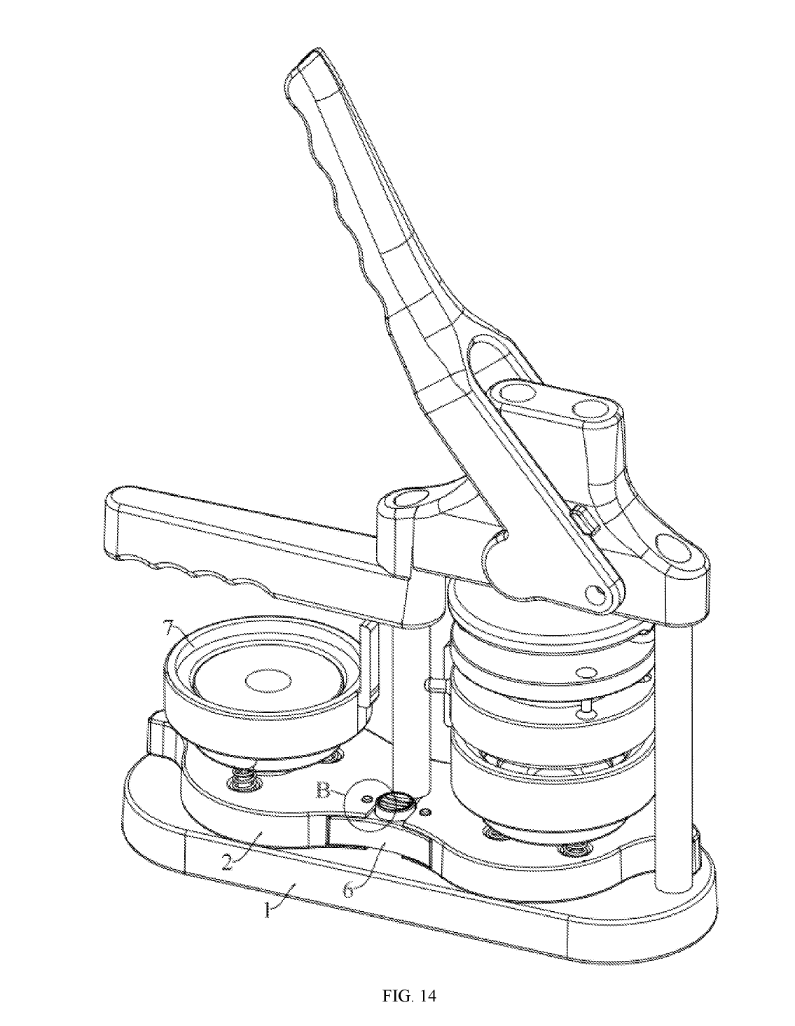

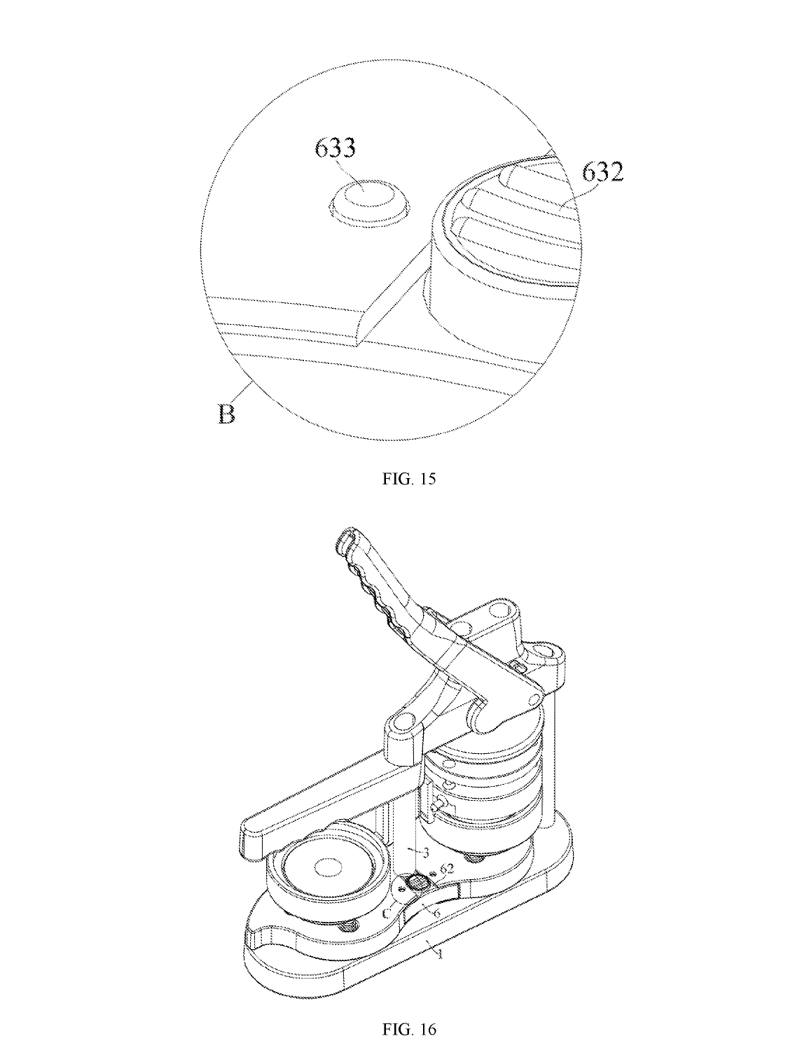

Referring to FIGS. 14 and 15, when it is necessary to switch to the unlocked state, firstly, the push button 632 needs to be pressed, and the compressed spring 64 is compressed, the inner connecting plate 631 descends, and drives the positioning post 633 fixed on the inner connecting plate 631 to descend to be separated from the positioning hole 27. Then, the base is pushed out to a rear side. During a pushing out process, the push button 632 can be released. In this case, the push button 632 slides along the upper guide opening 261, and the guide sheet 614 slides along the lower guide opening 262. When the base completely slides out of the lateral slot 26, unlocking is completed.

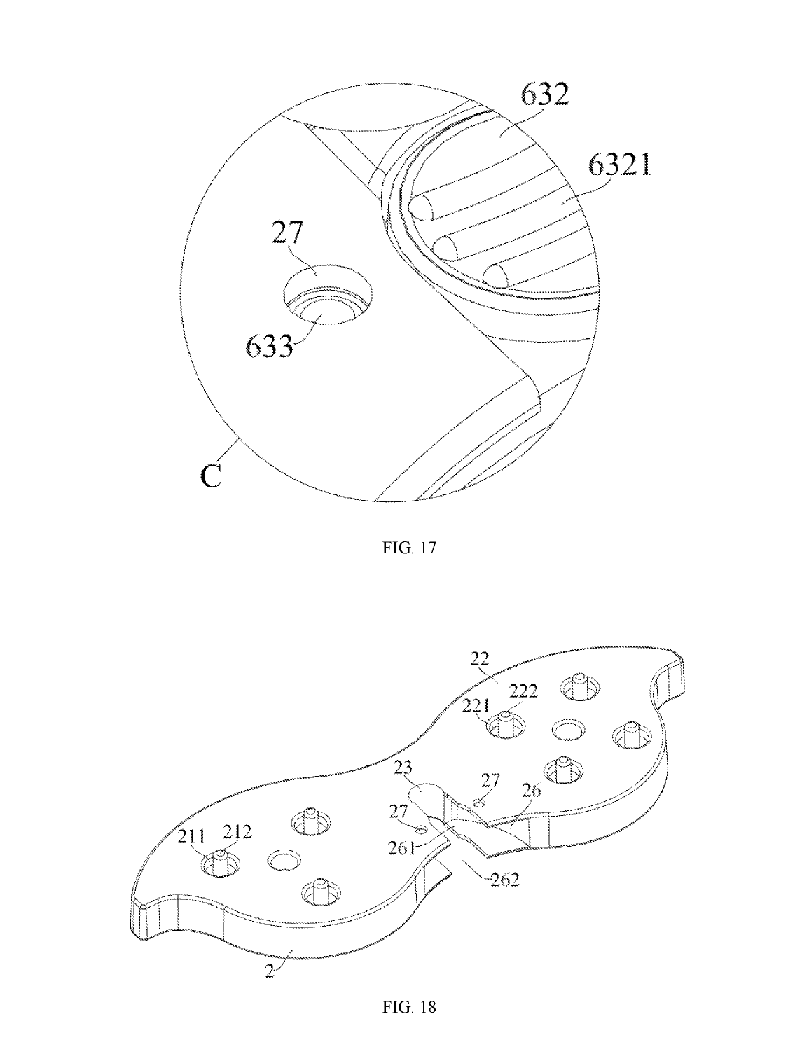

Referring to FIGS. 16 and 17, when it is necessary to switch to the locked state again, firstly, the base needs to be pushed forward into the lateral slot 26. Similarly, the push button 632 slides along the upper guide opening 261, and the guide sheet 614 slides along the lower guide opening 262. During the pushing process, the user needs to press the push button 632, such that the positioning post 633 can be aligned with the positioning hole 27 smoothly. Then, the push button 632 is released, the compressed spring 64 recovers through deformation, and pushes the inner connecting plate 631 upward, such that the positioning post 633 can smoothly enter the positioning hole 27, and locking is completed.

It should be noted that in this example, the structure of the adapter upright rod 3 is the same as that in Example 1 and Example 2, and in the locked state, a front end of the base will abut against an outer wall of the inner connecting rod 32.

What are described above about the auxiliary structure for die replacement of a badge machine of the present disclosure are only preferred examples of the present disclosure and do not limit the patentable scope of the present disclosure, and equivalent structural transformation made by utilizing the contents of the description and accompanying drawings of the present disclosure or direct/indirect application in other related technical fields fall within the patentable scope of protection of the present disclosure under the inventive concept of the present disclosure.

What is claimed is:

1. An auxiliary structure for die replacement of a badge machine, wherein the badge machine is provided with a bottom plate, an adapter upright rod and a rotating plate, the adapter upright rod extends vertically and is fixed above the bottom plate, a front side edge of the rotating plate is provided with a clamping slot hole, the rotating plate is rotationally mounted on the adapter upright rod through the clamping slot hole, and the rotating plate is placed above the bottom plate; the auxiliary structure for die replacement comprises a locking matching end arranged on the rotating plate and an unlocking assembly mounted at the locking matching end, wherein the unlocking assembly at least comprises a mounting main body and a locking member; the auxiliary structure for die replacement has a locked state and an unlocked state, in the locked state, the locking member is connected to the locking mating end, the mounting main body is locked and mounted behind the clamping slot hole, and the adapter upright rod is restricted from being separated backward from the clamping slot hole; and in the unlocked state, the locking member and the locking matching end are disconnected, the mounting main body is capable of moving relative to the rotating plate and releases locking of the adapter upright rod, and the adapter upright rod is capable of being separated backward from the clamping slot hole.

2. The auxiliary structure for die replacement of a badge machine according to claim 1, wherein the locking matching end at least comprises a fixing hole formed at the rotating plate, the locking member is provided with at least a fixing rod, and the fixing rod is correspondingly inserted into the fixing hole in the locked state; and in the unlocked state, the fixing rod is separated from the fixing hole, the clamping slot hole divides the rotating plate into a left station plate and a right station plate, a first lower die holder is fixedly mounted above the left station plate, a second lower die holder is fixedly mounted above the right station plate, a mounting vacancy for mounting the mounting main body is arranged on the rotating plate, and the mounting vacancy is arranged behind the clamping slot hole.

3. The auxiliary structure for die replacement of a badge machine according to claim 2, wherein the unlocking assembly is a first unlocking assembly, the locking member is a first fastening member, the mounting main body comprises a shifting and rotating main body, one end of the shifting and rotating main body is rotationally mounted on the right station plate, the other end of the shifting and rotating main body is used for being fastened and mounted on the left station plate in cooperation with the first fastening member, and in the locked state, a front end of the shifting and rotating main body abuts against the adapter upright rod.

4. The auxiliary structure for die replacement of a badge machine according to claim 3, wherein a first mounting slot position is arranged at a side, closest to the mounting vacancy, of the left station plate, a second mounting slot position is arranged at a side, closest to the mounting vacancy, of the right station plate, the fixing hole is a first screw hole provided at the first mounting slot position, a rotating shaft hole is provided at the second mounting slot position, one end of the shifting and rotating main body is provided with a first through hole, the other end of the shifting and rotating main body is provided with an adapter, the adapter is rotationally mounted in the rotating shaft hole, in the locked state, the first through hole and the first screw hole correspond to each other up and down, one end of the first fastening member is fastened and mounted in the first screw hole after passing through the first through hole, and in the unlocked state, the shifting and rotating main body rotates freely around the rotating shaft hole through the adapter.

5. The auxiliary structure for die replacement of a badge machine according to claim 4, wherein a first boss is arranged on the shifting and rotating main body, the first through hole is provided at the first boss, the first fastening member comprises a first knob and a first screw rod that are connected to each other, the first knob abuts against an upper portion of the first boss in the locked state, an insertion sheet is arranged on one side of the shifting and rotating main body, and the insertion sheet extends into the clamping slot hole in the locked state, and abuts against an outer side wall of the adapter upright rod.

6. The auxiliary structure for die replacement of a badge machine according to claim 2, wherein the unlocking assembly is a second unlocking assembly, the locking member is a second fastening member, the mounting main body comprises a push plate, in the locked state, the push plate is fastened and mounted on the left station plate or the right station plate through the second fastening member, and in the unlocked state the push plate slides into or out of the mounting vacancy.

7. The auxiliary structure for die replacement of a badge machine according to claim 6, wherein a first mounting slot position is arranged at a side, closest to the mounting vacancy, of the left station plate, a second mounting slot position is arranged at a side, closest to the mounting vacancy, of the right station plate, the fixing hole is a second screw hole provided at the first mounting slot position, a second through hole is provided at the push plate, in the locked state, the second through hole and the second screw hole correspond to each other up and down, and one end of the second fastening member is fastened and mounted in the second screw hole after passing through the second through hole.

8. The auxiliary structure for die replacement of a badge machine according to claim 7, wherein a second boss, and a handle bar extending in a left-right direction are arranged above the push plate, the second through hole extends upward to the second boss, the second fastening member comprises a second knob and a second screw rod that are connected to each other, the second knob abuts against an upper portion of the second boss in the locked state, and a notch matches and abuts against the adapter upright rod is provided at a front end of the push plate.

9. The auxiliary structure for die replacement of a badge machine according to claim 2, wherein the unlocking assembly is a third unlocking assembly, the mounting main body comprises a base, the locking member is a pressing member elastically mounted on the base, the base is slidably mounted in the mounting vacancy in a front-rear direction, and in the locked state, the pressing member cooperates to fasten and mount the base on the rotating plate; and in the unlocked state, the base and the pressing member jointly slide into or out of the mounting vacancy.

10. The auxiliary structure for die replacement of a badge machine according to claim 9, wherein the base comprises a base plate and an upper housing mounted above the base plate, the base plate is provided with a mounting seat for mounting a compressed spring, the pressing member comprises an inner connecting plate arranged inside the upper housing, a push button fixed above the inner connecting plate and at least one positioning post, the rotating plate is provided with at least one positioning hole, the compressed spring is arranged between the mounting seat and the push button, the positioning post and an upper end of the push button extend to a position above the upper housing in the locked state, and the positioning post is inserted into the positioning hole.
